(19) United States
(12) Patent Application Publication
(10) Pub. No.: US 2018/0100295 A1
(43) Pub. Date: Apr. 12, 2018

(54) Shower assembly

(71) Applicants: Roy Dean Olsen, Sioux City, IA (US); Melanie Ann Olsen, Sioux City, IA (US)

(72) Inventors: Roy Dean Olsen, Sioux City, IA (US); Melanie Ann Olsen, Sioux City, IA (US)

(21) Appl. No.: 15/290,802

(22) Filed: Oct. 11, 2016

(51) Int. Cl. E03C 1/04; E03C 1/06; B05B 1/18

(52) U.S. Cl. CPC E03C 1/0408; B05B 1/185; E03C 1/06

(57) ABSTRACT

A shower system is disclosed herein. The system uses a tubular loop that may be retrofitted around an existing shower control system. The tubular loop is provided with a plurality of shower heads that may be adjusted by the user both in direction and pressure to direct additional shower spray as desired by the user. The shower system of the present invention is portable and may be quickly and easily non-destructively added to or removed from an existing shower system.

### TECHNICAL FIELD

The present invention relates, in general, to a shower assembly and, more particularly, to a shower assembly having a continuous loop fitted with a plurality of shower sprays.

### BACKGROUND OF THE INVENTION

Showers are well-known in the art. Typically, a shower head is positioned near the top of a shower stall and is controlled by a controller located below the shower head. While shower heads are useful, it is desirable to have additional spray heads located below the shower head to spray the body with water while the shower head rains water downward on a user.

While it is known in the art to provide showers with a shower head and a plurality of laterally-oriented sprays to direct water on to the body, such showers are expensive and it is costly and time-consuming to retrofit an existing shower with a plurality of body sprays. Typically, the shower wall must be removed so that the plumbing for the body sprays may be installed and the body sprays positioned through the shower wall. It would therefore be desirable to provide a shower assembly that may be quickly and inexpensively provided on an existing shower head.

It is also known in the art to retrofit existing shower heads with a hose and hand-held sprayer which may be removed from a retainer and manually directed to spray water to a desired location. One drawback associated with such prior devices is that while the sprayer may be directed as desired by the user, the user typically has to occupy at least one hand holding and directing the sprayer. An additional drawback associated with such devices is that when the sprayer is directing spray on the body, the user is no longer experiencing the shower head's spray falling downward on the user's head. It would therefore be desirable to provide a shower assembly that may be retrofitted on an existing shower head that may be used hands-free, directing spray both downward on the head and laterally toward a user's body.

It is also known in the art to provide additional sprayers onto the hose of a removable hand-held sprayer. While such a configuration does allow for a user to experience hands-free downward spray on to the body while experiencing laterally-directed spray on to the body, the hose may twist, thereby directing the hose-mounted sprayers undesired directions. When such prior art sprayers are removed from the retainer and used in a handheld orientation, the hose-mounted sprayers may become even more difficult to direct as desired. An additional drawback associated with such prior devices is that if the hose is long enough to allow the spray heads on the hose to be directed on to the body, the hose may interfere with the shower controls. It would therefore be desirable to provide a shower assembly that may be retrofitted onto an existing shower head that provides for hands-free downward spray and lateral body spray without interfering with the shower controls.

The difficulties encountered discussed herein above are substantially limited by the present invention.

### SUMMARY OF THE DISCLOSED SUBJECT MATTER

A shower system for use with a shower assembly having a wall defining an interior side and an exterior side. The shower assembly has a shower head assembly and a shower control assembly. The shower head assembly extends through the wall and has a shower head located on the interior of the wall. The shower control assembly extends through the wall and has a control located on the interior side of the wall. The shower head assembly is coupled to the shower control assembly on the exterior side of the wall. The shower system of the present invention is provided with a tubular loop on the interior side of the wall in fluid communication with the shower head assembly. The tubular loop surrounds at least a portion of the control. A low sprayer is coupled in fluid communication with the tubular loop below the control. A high sprayer is coupled in fluid communication with the tubular loop between the shower head assembly and the low sprayer.

One aspect of the shower system is the ability to quickly retrofit an existing shower assembly with the shower system.

Another aspect of the shower system is the ability to control the strength of spray from various sprayers on the tubular loop.

Another aspect of the shower system is the low cost of installing the system.

These and other aspects will be more readily understood by reference to the following description and figures.

### BRIEF DESCRIPTION OF THE DRAWINGS

The present invention will now be described, by way of example, with reference to the accompanying drawings in which:

FIG. 1 illustrates a side elevation in cross-section of a prior art shower assembly for use in association with the shower system of the present invention;

FIG. 2 illustrates a front perspective view of the shower system of the present invention used in association with a prior art shower assembly;

FIG. 3 illustrates a side elevation in cross-section of the shower system of the present invention used in association with a prior art shower assembly;

FIG. 4 illustrates a front elevation of the shower system of the present invention shown collapsed for transport and storage.

### DETAILED DESCRIPTION OF THE DRAWINGS

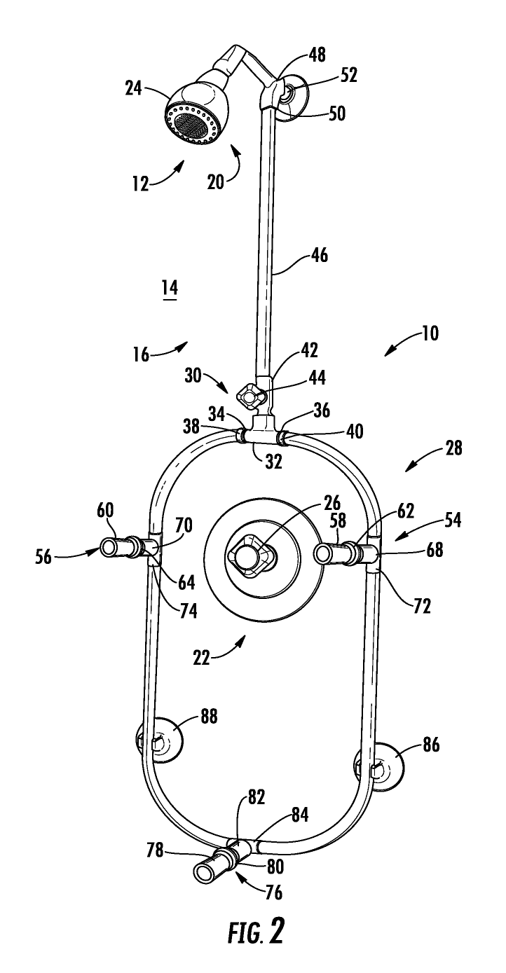

A shower system is shown generally as (10) in FIG. 2. The embodiments of the invention described below are illustrative only, and are not to be interpreted by limiting the scope of the present invention.

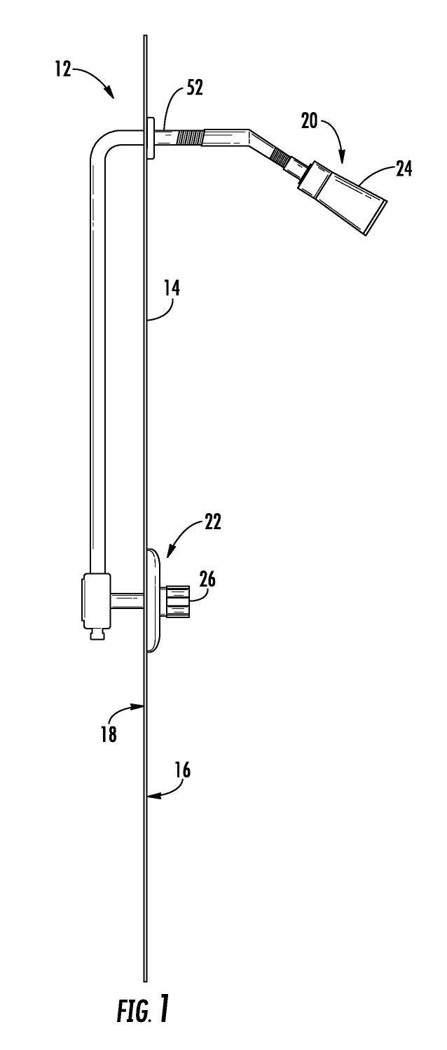

The shower system (10) (not shown) is used in association with a shower assembly (12) as shown in FIG. 1. The shower assembly (12) is provided with a shower wall (14) defining an interior side (16) and an exterior side (18). The shower assembly (12) has a shower head assembly (20) and a shower control assembly (22). The shower head assembly (20) is provided with a shower head (24), while the shower control assembly (22) is provided with a control (26). Both the shower head assembly (20) and shower control assembly (22) extend through the shower wall (14). The shower head (24) and control (26) are located on the interior side (16) of the shower wall (14). As shown, the shower head assembly (20) is coupled to the shower control assembly (22) on the exterior side (18) of the shower wall (14) in a manner such as that known in the art.

As shown in FIG. 2, the shower system (10) of the present invention is coupled to the shower assembly (12) without the need to breach the shower wall (14) or otherwise destroy portions of the existing shower assembly (12). The shower system (10) has a tubular loop (28) provided on the interior side (16) of the shower wall (14). While the tubular loop (28) may be constructed of any desired material, such as metal or plastic, in the preferred embodiment, the tubular loop (28) is constructed of one-half-inch diameter acrylonitrile butadiene styrene (ABS). As shown in FIG. 2, the tubular loop (28) is preferably in the shape of an oblong, such as the rounded rectangle, but may be of any desired dimensions, such as circular or rectangular. Preferably, all threaded connections are made with a gasket material such a polytetrafluoroethylene tape, rubber gasket, or similar watertight connection system. While the tubular loop (28) may be provided with any amount of rigidity, from being constructed of a flexible hose to a rigid pipe, in the preferred embodiment, the tubular loop (28) is sufficiently rigid to prevent the tubular loop (28) from being deformed from its square rectangular shape due to its own weight. The tubular loop (28) is provided around the control (26) to allow access to the control (26) without interference from the shower system (10).

In the preferred embodiment, the tubular loop (28) has a width preferably between 5 and 30 inches, more preferably between 10 and 20 inches, and most preferably around 13 inches. The tubular loop (28) is preferably provided with a height between 5 and 50 inches, more preferably between 10 and 30 inches, and most preferably about 23 inches. As shown, the tubular loop (28) is constructed of several individual one-half-inch diameter ABS coupled to one another, including straight pieces, curved pieces and elbow connectors. The tubular loop (28) may alternatively be constructed of a single piece of one-half-inch diameter ABS tubing. Secured to the top (30) of the tubular loop (28) is a T-joint (32). The T-joint (32) may be constructed of any suitable known material such as metal or plastic, but is preferably constructed of ABS. Alternatively, the tubular loop (28) may be integrally provided with a T-joint (32) or the T-joint (32) may be permanently secured to the tubular loop (28). The T-joint (32) is preferably coupled to the tubular loop (28) by a pair of adapters (34 and 36). The adapters (34 and 36) are one-half-inch diameter ABS trap adapters with nuts (38 and 40), such as those known in the art.

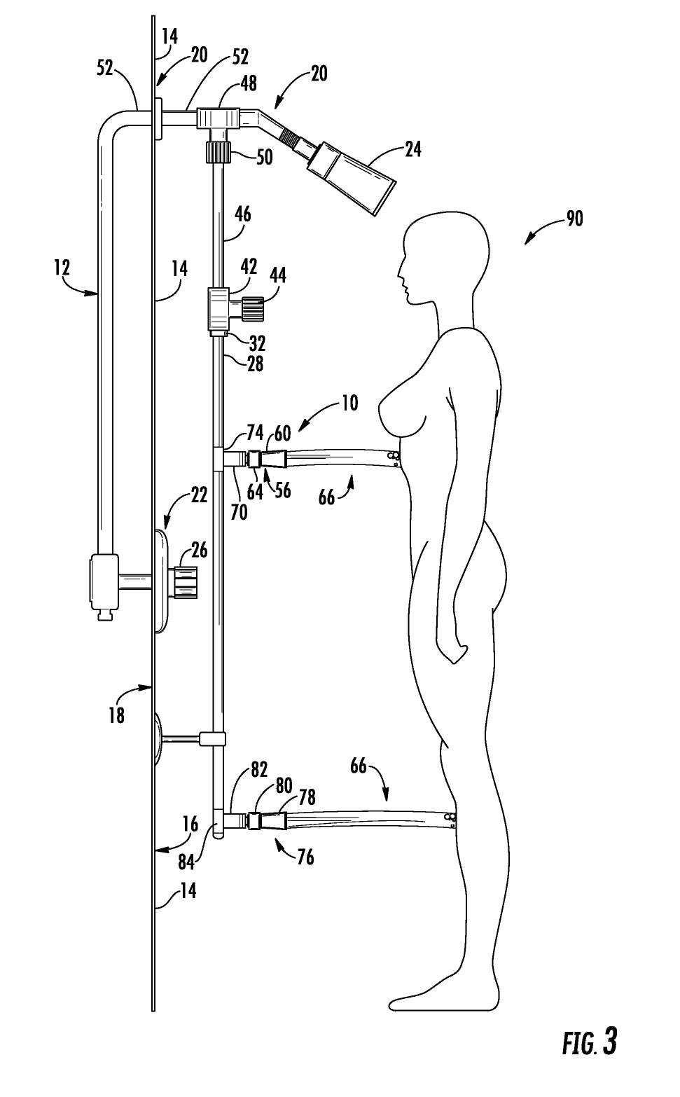

Coupled to the T-joint (32) is a brass valve (42) such as those known in the art, having a knob (44) that may be turned a quarter turn to shut off flow of water to the T-joint (32) and tubular loop (28) if it is desired to use the shower assembly (12) without the shower system (10). Secured to the brass valve (42) is a length of one-half-inch diameter ABS pipe (46). The length of the pipe (46) may be of any desired length, but is preferably between one and 40 inches, more preferably between 5 and 30 inches, and most preferably about 20 inches. The length and dimensions of the components of the shower system (10) may be adjusted to provide sprays at different heights and/or to accommodate shower assemblies (12) of various dimensions. As shown in FIG. 3, the pipe (46) is coupled to a brass T-joint (48), such as those known in the art, by a nut (50).

To install the shower system (10) onto the shower assembly (12), the shower head (24) is removed from the shower head assembly (20), and the T-joint (48) threadably secured into mating engagement with both the shower head (24) and the shower head connecting pipe (52) in a manner such as that shown in FIG. 3.

As shown in FIGS. 2-3, provided on the tubular loop (28) are a pair of high sprayers which in the preferred embodiment are shower heads (54 and 56). The shower heads (54 and 56) may be of any suitable type known in the art, but are preferably 1.5 gallons per minute (gpm) threaded nozzles such as model USB3C 1.5 GPM Ultra Saver high velocity shower head spray nozzles manufactured by Whedon Products, Inc. of West Hartford, Conn. The shower heads (54 and 56) are provided with fluid restrictors which in the preferred embodiment are twistable outer housings (58 and 60) such as those known in the art to reduce the spray pressure of the shower heads (54 and 56) in response to the housings (58 and 60) being twisted in a first direction and to increase the spray pressure of the shower heads (54 and 56) in response to the housings (58 and 60) being twisted in a second direction. The shower heads (54 and 56) are provided with adjustable mounts (62 and 64) such as those known in the art to maintain the shower heads (54 and 56) in a predetermined orientation using friction, but that allow the shower heads (54 and 56) to be manually redirected to a new orientation directing spray (66) from shower heads (54 and 56) in a new direction.

As shown in FIG. 2 the shower heads (54 and 56) are provided with threaded ends that are threadably engaged to pipe nipples (68 and 70) which are in turn threadably coupled to a pair of T-joints (72 and 74) coupled in line with the tubular loop (28). While the shower heads (54 and 56) are shown located above the control (26), the shower heads (54 and 56) may be located anywhere along the tubular loop (28) as desired. Additionally, a low sprayer, such as the shower head (76), similar to the shower heads (54 and 56), is provided with a twistable outer housing (78) and adjustable mount (80) and threadably coupled to a pipe nipple (82), which in turn is threadably coupled into a T-joint (84) coupled in fluid communication with the tubular loop (28). While the shower head (76) may be provided along the tubular loop (28) in any desired location, the shower head (76) is preferably provided at the lowest point of the tubular loop (28) to allow drainage from the tubular loop (28) through the shower head (76). As shown in FIG. 2, the tubular loop (28) is also provided with a pair of fasteners, such as suction cups (86 and 88) that are provided around the tubular loop (28) and secured to the shower wall (14). Any desired number of suction cups (86 and 88) may provided in any design, orientation, or location around the tubular loop (28).

The twistable outer housings (58, 60, and 78) of the shower heads (54, 56, and 76) are preferably adjusted to vary the amount of spray (66) passing through the shower heads (54, 56, and 76). By opening the twistable outer housings (58 and 60) of the shower heads (54 and 56) more than the twistable outer housing (78) of the shower head (76) the pressure of the spray (66) emanating from the shower heads (54, 56, and 76) can be equalized to account of the increased pressure of the shower head (76) being lower than the upper shower heads (54 and 56). Alternatively, the twistable outer housings (58, 60, and 78) of the shower heads (54, 56, and 76) may be adjusted to vary the pressure of the spray (66) so that one or more of the shower heads (54, 56, and 76) has a greater pressure of spray (66) than one or both of the other shower heads (54, 56, and 76). As shown in FIG. 2, the high shower heads (54 and 56) are located above the control (26) while the low shower head (76) is located below the control (26). The shower system (10) is preferably configured to provide spray to a user (90) simultaneously through all four shower heads (24, 54, 56, and 76) while allowing the user (90) access to the control (26) without interference by the shower system (10). Alternatively, one or more of the shower heads (24, 54, 56, and 76) may be twisted closed to prevent them from spraying during use of the shower system (10) and the shower assembly (12).

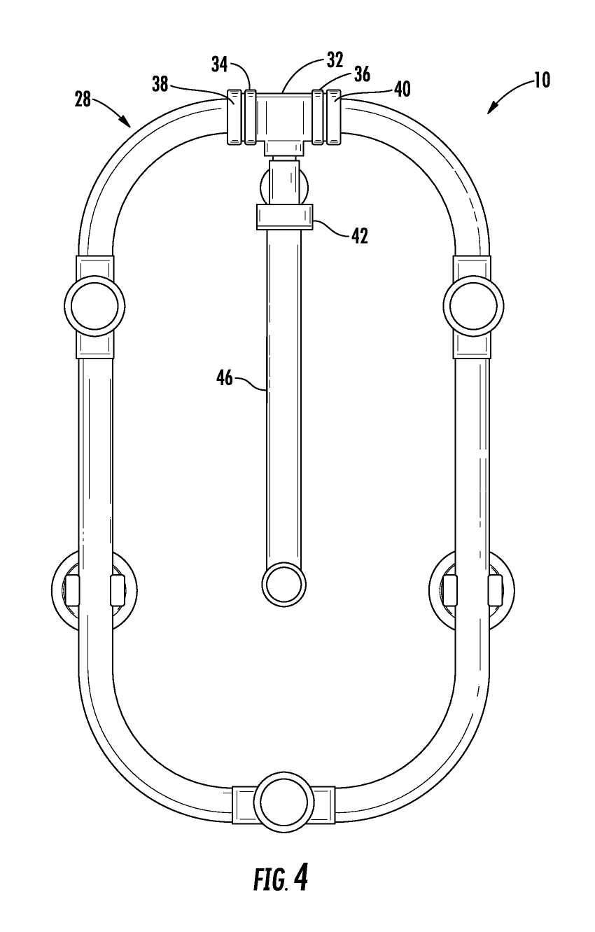

The shower system (10) is preferably stored and transported in a collapsed position, with the pipe (46) pivoted into the tubular loop (28). (FIG. 4) The nuts (38 and 40) may be tightened to prevent the T-joint (32) from pivoting out of the tubular loop (28) during transport and storage. When it is desired to install the shower system (10), the nuts (38 and 40) are loosened and the pipe (46) is rotated out of the tubular loop (28) to a position substantially parallel to the tubular loop (28) as shown in FIGS. 2-3. Once the pipe (46) has been rotated into position, the nuts (38 and 40) are again tightened to secure the position of the pipe (46) relative to the tubular loop (28).

The shower head (24) is unthreaded from the shower head assembly (20) and the T-joint (32) is threaded to the connecting pipe (52) and to the shower head (24). A nipple (not shown) may be used to connect the T-joint (32) if needed. Once the T-joint (32) of the shower system (10) has been secured to the shower head assembly (20), the suction cups (86 and 88) are secured to the shower wall (14). Thereafter, the user (90) may adjust the control (26) to begin the flow of spray (66) to the shower head (24) and shower assembly (12). Once the desired flow of water has been initiated, the user (90) may open the valve (42) to direct water to through the tubular loop (28). The user (90) may then adjust the pressure and direction of the shower heads (54, 56, and 76) as desired. As shown in FIG. 3, the user (90) has adjusted the shower heads (54, 56, and 76) so that each shower head (54, 56, and 76) sprays the user (90) with the same amount of pressure, despite the shower heads (54 and 56) being higher than the shower head (76). As noted above, the user (90) may adjust the pressures as desired to increase the force of spray (66) from one or more of the shower heads (24, 54, 56, and 76) relative to the force of the spray (66) from the other shower heads (24, 54, 56, and 76).

If it is desired to remove the shower system (10) from the shower assembly (12), the suction cups (86 and 88) are removed from the shower wall (14). The T-joint (32) is unthreaded from the connecting pipe (52) and shower head (24), and the shower head (24) is reattached to the shower head assembly (20). The nuts (38 and 40) are then loosened, and the pipe (46) rotated to the orientation shown in FIG. 4, whereafter the nuts (38 and 40) are tightened for transport or storage of the shower system (10).

Although the invention has been described with respect to a preferred embodiment thereof, it is to be understood that it is not to be so limited since changes and modifications can be made therein which are within the full intended scope of this invention as defined by the appended claims.

What is claimed is:

1. A shower system for use with a shower assembly having a wall defining an interior side and an exterior side, a shower head assembly extending through the wall wherein the shower head assembly has a shower head located on the interior side of the wall, a shower control assembly extending through the wall wherein the shower control assembly has a control located on the interior side of the wall, wherein the shower head assembly is coupled to the shower control assembly on the exterior side of the wall, the shower system comprising:
a) a tubular loop provided on the interior side of the wall configured for fluid communication with the shower head assembly, wherein the tubular loop is configured to surround at least a portion of the control;
b) a low sprayer coupled in fluid communication with the tubular loop wherein the low sprayer is configured for location at a first point below at least a portion of the control; and
c) a high sprayer coupled in fluid communication with the tubular loop wherein the high sprayer is configured for location at a second point between the shower head assembly and the low sprayer.

2. The shower system of claim 1, further comprising a fluid restrictor in fluid communication with the tubular loop, wherein the fluid restrictor is configured to reduce a pressure of a fluid passing through the tubular loop to the low sprayer.

3. The shower system of claim 2, further comprising a supplemental high sprayer coupled in fluid communication with the tubular loop, wherein the supplemental high sprayer is configured for location at a third point located between the shower head assembly and the low sprayer on a side of the tubular loop to which the high sprayer is not coupled.

4. The shower system of claim 1, further comprising a supplemental high sprayer coupled in fluid communication with the tubular loop, wherein the supplemental high sprayer is configured for location at a third point located between the shower head assembly and the low sprayer on a side of the tubular loop to which the high sprayer is not coupled.

5. The shower system of claim 1, further comprising a supplemental high sprayer coupled in fluid communication with the tubular loop, wherein the low sprayer is adjustable between a first position directing a fluid spray in a first direction and a second position directing a fluid spray in a second direction.

6. The shower system of claim 5, wherein the supplemental high sprayer is configured for location at a third point located between the shower head assembly and the low sprayer on a side of the tubular loop to which the high sprayer is not coupled.

7. The shower system of claim 1, wherein the low sprayer is configured to provide a lower volume of fluid than the shower head assembly.

8. The shower system of claim 1, further comprising a fastener configured for coupling the tubular loop to the wall.

9. The shower system of claim 1, further comprising a tubular neck coupled in fluid communication with the tubular loop.

10. The shower system of claim 9, wherein the tubular neck is rotatably coupled to the tubular loop.

11. The shower system of claim 10, further comprising a fastener configured for coupling the tubular loop to the wall.

12. A shower system comprising:
a) a tubular loop provided in fluid communication with a shower head assembly provided on an interior side of a shower wall, wherein the tubular loop surrounds at least a portion of a shower control assembly, wherein the shower control assembly is coupled to the shower head assembly on an exterior side of the shower wall;
b) a low sprayer coupled in fluid communication with the tubular loop at a point located below at least a portion of the shower control assembly; and
c) a high sprayer coupled in fluid communication with the tubular loop at a point located between the shower head assembly and the low sprayer.

13. The shower system of claim 12, further comprising a fluid restrictor in fluid communication with the tubular loop wherein the fluid restrictor is configured to reduce a pressure of a fluid supplied to the low sprayer.

14. The shower system of claim 13, further comprising a supplemental high sprayer coupled in fluid communication with the tubular loop at a point located between the shower head assembly and the low sprayer on the opposite side of the shower control assembly from the high sprayer.

15. The shower system of claim 12, further comprising a supplemental high sprayer coupled in fluid communication with the tubular loop, wherein the supplemental high sprayer is configured for location at a third point located between the shower head assembly and the low sprayer on a side of the tubular loop to which the high sprayer is not coupled.

16. The shower system of claim 12, further comprising a fastener configured for coupling the tubular loop to the shower wall.

17. The shower system of claim 12, further comprising a tubular neck coupled in fluid communication with the tubular loop.

18. The shower system of claim 17, wherein the tubular neck is rotatably coupled to the tubular loop.

19. A method for connecting a shower system to a shower assembly having a wall defining an interior side and an exterior side, a shower head assembly extending through the wall, wherein the shower head assembly has a sprayer located on the interior side of the wall, a shower control assembly extending through the wall wherein the shower control assembly has a control located on the interior side of the wall, wherein the shower head assembly is coupled to the shower head assembly on the exterior side of the wall, the method comprising:
a) coupling a tubular loop to the shower head assembly on the interior side of the wall wherein the tubular loop has a low sprayer coupled in fluid communication with the tubular loop and a high sprayer coupled in fluid communication with the tubular loop;
b) encircling the control with the tubular loop on the interior side of the wall so as to position the low sprayer at least partially below the control and so as to position the high sprayer between the shower head assembly and the low sprayer; and
c) actuating the control to direct fluid out of the low sprayer and the high sprayer.

20. The method of claim 19, further comprising restricting pressure of the fluid between the high sprayer and the low sprayer.
